(19) United States
(12) Patent Application Publication
(10) Pub. No.: US 2022/0076360 A1
(43) Pub. Date: Mar. 10, 2022

(54) CONTROL DEVICE, SYSTEM, PROGRAM, TERMINAL DEVICE, AND SERVICE SUPPORT METHOD

(71) Applicant: Toyota Jidosha Kabushiki Kaisha, Toyota-shi Aichi-ken (JP)

(72) Inventors: Kotaro Okabe, Ichikawa-shi (JP); Tomo Sasaki, Toyota-shi (JP); Koichi Suzuki, Miyoshi-shi (JP); Genshi Kuno, Kasugai-shi (JP); Koichi Hirano, Toyota-shi (JP); Makoto Yamazaki, Nagoya-shi (JP)

(73) Assignee: Toyota Jidosha Kabushiki Kaisha, Toyota-shi Aichi-ken (JP)

(21) Appl. No.: 17/372,997

(22) Filed: Jul. 12, 2021

(30) Foreign Application Priority Data
Sep. 4, 2020 (JP) 2020-149362

(51) Int. Cl. G06Q 50/12; G05B 19/042; G06Q 10/06; A47J 36/32; G06F 3/14; G06K 9/00

(52) U.S. Cl. CPC G06Q 50/12; G05B 19/042; G06Q 10/06312; G06Q 10/06316; G05B 2219/2643; A47J 36/321; G06F 3/14; G06K 9/00624; G06K 9/00335; G06Q 10/063114

(57) ABSTRACT

A control device includes: a control unit configured to detect a progress status of cooking of one or more dishes ordered by a customer; and a communication unit configured to send notice data to a terminal device that is used by the customer, the notice data being data about a notice of the progress status detected by the control unit.

### CROSS-REFERENCE TO RELATED APPLICATION

This application claims priority to Japanese Patent Application No. 2020-149362 filed on Sep. 4, 2020, incorporated herein by reference in its entirety.

### BACKGROUND

### 1. Technical Field

The present disclosure relates to a control device, a system, a program, a terminal device, and a service support method.

### 2. Description of Related Art

Japanese Unexamined Patent Application Publication No. 2016-012368 (JP 2016-012368 A) discloses a technology for giving an instruction to start the cooking of the next dish depending on the progress status of eating by a customer.

### SUMMARY

In the related art, the customer cannot know the progress status of the cooking.

An object of the present disclosure is to allow the customer to know the progress status of the cooking.

A control device according to the present disclosure includes: a control unit configured to detect a progress status of cooking of one or more dishes ordered by a customer; and a communication unit configured to send notice data to a terminal device that is used by the customer, the notice data being data about a notice of the progress status detected by the control unit.

A program according to the present disclosure causes a computer to execute an action comprising: receiving notice data from a control device configured to detect a progress status of cooking of one or more dishes ordered by a customer, the notice data being data about a notice of the progress status; performing a control to output the received notice data; generating request data depending on an operation by the customer, the request data being data about a request for an adjustment of a proceeding way for the cooking; and sending the generated request data as a response to the notice data.

A service support method according to the present disclosure includes: detecting a progress status of cooking of one or more dishes ordered by a customer, using a control device; and sending notice data from the control device to a terminal device that is used by the customer, the notice data being data about a notice of the detected progress status.

With the present disclosure, the customer can know the progress status of the cooking.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a system according to an embodiment of the present disclosure;

FIG. 2 is a block diagram showing the configuration of a control device according to the embodiment of the present disclosure;

FIG. 3 is a block diagram showing the configuration of a first terminal device according to the embodiment of the present disclosure;

FIG. 4 is a block diagram showing the configuration of a second terminal device according to the embodiment of the present disclosure;

FIG. 5 is a flowchart showing the action of the control device according to the embodiment of the present disclosure;

FIG. 6 is a flowchart showing the action of the first terminal device according to the embodiment of the present disclosure; and

FIG. 7 is a flowchart showing the action of the second terminal device according to the embodiment of the present disclosure.

### DETAILED DESCRIPTION OF EMBODIMENTS

An embodiment of the present disclosure will be described below with reference to the drawings.

In the drawings, identical or corresponding parts are denoted by identical reference characters. In the description of the embodiment, descriptions of identical or corresponding parts will be omitted or simplified when appropriate.

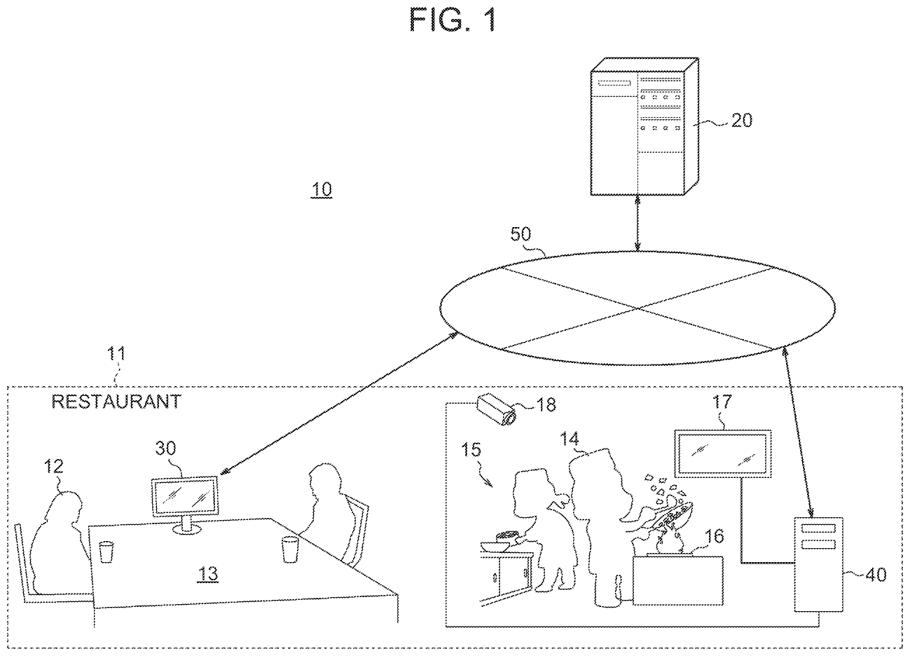

The outline of the embodiment will be described with reference to FIG. 1.

In the embodiment, the progress status of the cooking of one or more dishes ordered by a customer 12 is detected by a control device 20. Notice data D1 about a notice of the detected progress status is sent from the control device 20 to a first terminal device 30 that is used by the customer 12. Accordingly, the customer 12 can know the progress status of the cooking.

In the embodiment, request data D2 about a request for an adjustment of the proceeding way for the cooking is generated by the first terminal device 30, depending on an operation by the customer 12. The generated request data D2 is sent from the first terminal device 30 to the control device 20, as a response to the notice data D1. Accordingly, the customer 12 can make a request relevant to the cooking depending on the progress status of the cooking.

In the embodiment, instruction data D3 about an instruction on the proceeding way for the cooking is generated by the control device 20, based on the request data D2. The instruction data D3 is sent from the control device 20 to a second terminal device 40 that is used by a cooking staff 14. Accordingly, the cooking staff 14 can cope with the demand from the customer 12.

In the embodiment, the request data D2 includes data about a request for an adjustment of the sequence or pace of the cooking of the dishes. Accordingly, when the customer 12 requests to change the sequence of the dishes or when the customer 12 requests to decrease the pace of the cooking, the cooking staff 14 can cope with the request.

The configuration of a system 10 according to the embodiment will be described with reference to FIG. 1.

The system 10 includes at least one control device 20, at least one first terminal device 30, and at least one second terminal device 40.

The control device 20 is installed in a facility such as a data center. The control device 20 is a computer such as a server in a cloud computing system or another computing system.

The first terminal device 30 is installed on a table 13 in a restaurant 11 in the embodiment, but may be installed at another place in the restaurant 11 or may be held by the customer 12. For example, the first terminal device 30 is a mobile device such as a portable telephone, a smartphone and a tablet, a PC, or a dedicated device for the restaurant 11. The “PC” is an abbreviation of personal computer.

The second terminal device 40 is installed at a kitchen 15 in the restaurant 11 in the embodiment, but may be installed at another place in the restaurant 11 or may be held by the cooking staff 14. For example, the second terminal device 40 is a mobile device such as a portable telephone, a smartphone and a tablet, a PC, or a dedicated device for the restaurant 11.

The second terminal device 40 is connected with a display 17 installed at the kitchen 15. As the connection scheme, for example, an arbitrary scheme such as USB, HDMI® or Bluetooth® can be used. The “USB” is an abbreviation of Universal Serial Bus. The “HDMI®” is an abbreviation of High-Definition Multimedia Interface. The display 17 is hung on a wall of the kitchen 15 in the embodiment, but may be disposed at an arbitrary position at which the cooking staff 14 can look. For example, the display 17 is an LCD or an organic EL display. The “LCD” is an abbreviation of liquid crystal display. The “EL” is an abbreviation of electro luminescence.

The second terminal device 40 is connected also with a camera 18 installed at the kitchen 15. As the connection scheme, for example, an arbitrary scheme such as USB or Bluetooth® can be used. The camera 18 is disposed at a position where the camera 18 can photograph an image of the cooking staff 14 and an image of a cooking device 16 such as a stove.

The control device 20 can communicate with the first terminal device 30 and the second terminal device 40 through a network 50. The first terminal device 30 and the second terminal device 40 may communicate with each other through the network 50.

The network 50 includes the internet, at least one WAN, at least one MAN, or an arbitrary combination of them. The “WAN” is an abbreviation of wide area network. The “MAN” is an abbreviation of metropolitan area network. The network 50 may include at least one wireless network, at least one optical network, or an arbitrary combination of them. For example, the wireless network is an ad-hoc network, a cellular network, a wireless LAN, a satellite communication network, or a terrestrial microwave network. The “LAN” is an abbreviation of local area network.

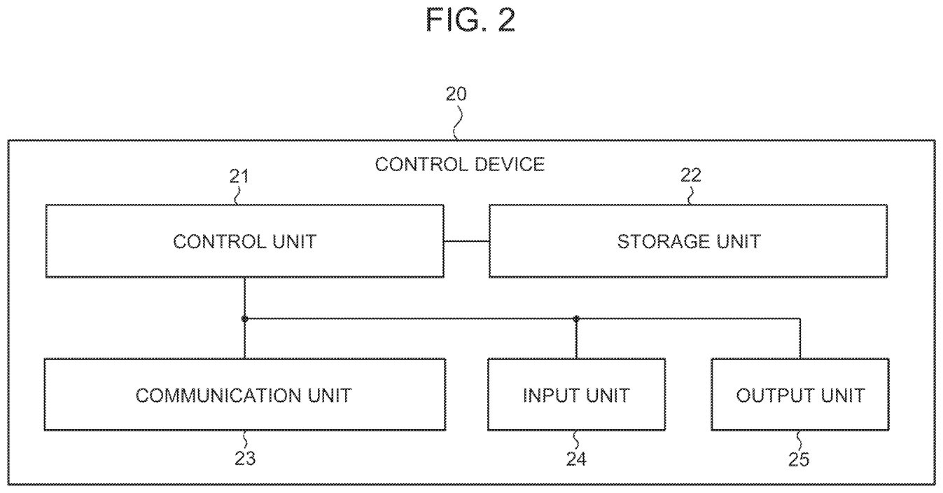

The configuration of the control device 20 according to the embodiment will be described with reference to FIG. 2.

The control device 20 includes a control unit 21, a storage unit 22, a communication unit 23, an input unit 24 and an output unit 25.

The control unit 21 includes at least one processor, at least one programmable circuit, at least one dedicated circuit, or an arbitrary combination of them. The processor is a general-purpose processor such as a CPU or a GPU, or a dedicated processor for a particular process. The “CPU” is an abbreviation of central processing unit. The “GPU” is an abbreviation of graphics processing unit. For example, the programmable circuit is an FPGA. The “FPGA” is an abbreviation of field-programmable gate array. For example, the dedicated circuit is an ASIC. The “ASIC” is an abbreviation of application specific integrated circuit. The control unit 21 executes processes relevant to the action of the control device 20, while controlling each unit of the control device 20.

The storage unit 22 includes at least one semiconductor memory, at least one magnetic memory, at least one optical memory, or an arbitrary combination of them. For example, the semiconductor memory is a RAM or a ROM. The “RAM” is an abbreviation of random access memory. The “ROM” is an abbreviation of read only memory. For example, the RAM is a SRAM or a DRAM. The “SRAM” is an abbreviation of static random access memory. The “DRAM” is an abbreviation of dynamic random access memory. For example, the ROM is an EEPROM. The “EEPROM” is an abbreviation of electrically erasable programmable read only memory. For example, the storage unit 22 functions as a main storage device, an auxiliary storage device or a cache memory. In the storage unit 22, data to be used for the action of the control device 20 and data obtained by the action of the control device 20 are stored.

The communication unit 23 includes at least one communication interface. For example, the communication interface is a LAN interface. The communication unit 23 receives the data to be used for the action of the control device 20, and sends the data obtained by the action of the control device 20.

The input unit 24 includes at least one input interface. For example, the input interface is a physical key, a capacitive key, a pointing device, a touch screen provided integrally with a display, a camera, or a microphone. The input unit 24 accepts an operation for inputting the data to be used for the action of the control device 20. The input unit 24 may be connected to the control device 20, as an external input device, instead of being included in the control device 20. As the connection scheme, for example, an arbitrary scheme such as USB, HDMI® or Bluetooth® can be used.

The output unit 25 includes at least one output interface. For example, the output interface is a display or a speaker. For example, the display is an LCD or an organic EL display. The output unit 25 outputs the data obtained by the action of the control device 20. The output unit 25 may be connected to the control device 20, as an external output device, instead of being included in the control device 20. As the connection scheme, for example, an arbitrary scheme such as USB, HDMI® or Bluetooth® can be used.

The function of the control device 20 is realized when a control program according to the embodiment is executed by a processor as the control unit 21. That is, the function of the control device 20 is realized by software. The control program causes a computer to execute the action of the control device 20, and thereby causes the computer to function as the control device 20. That is, the computer functions as the control device 20 by executing the action of the control device 20 in accordance with the control program.

The program can be recorded in a non-transitory computer-readable medium. For example, the non-transitory computer-readable medium is a flash memory, a magnetic recording device, an optical disc, a magneto-optical recording medium, or a ROM. For example, the program is distributed by selling, transferring or lending a portable recording medium such as an SD card, DVD or CD-ROM in which the program is recorded. The “SD” is an abbreviation of Secure Digital. The “DVD” is an abbreviation of digital versatile disc. The “CD-ROM” is an abbreviation of compact disc read only memory. The program may be distributed by storing the program in a storage of a server and transferring the program from the server to other computers. The program may be provided as a program product.

For example, the computer once stores the program recorded in the portable recording medium or the program transferred from the server, in the main storage device. Then, the computer reads the program stored in the main storage device, with the processor, and executes a process in accordance with the read program, with the processor. The computer may directly read the program from the portable recording medium, to execute the process in accordance with the program. The computer may execute a process in accordance with the received program, whenever the program is transferred from the server to the computer. Without the transfer of the program from the server to the computer, the process may be executed by a so-called ASP type service in which the function is realized only by execution instruction and result acquisition. The “ASP” is an abbreviation of application service provider. The program includes information that is used for a process by an electronic computer and that is similar to a program. For example, data that is not a command to be directly given to the computer but has a property of defining the process of the computer is included in the “information that is similar to a program”.

Some or all of the functions of the control device 20 may be realized by the programmable circuit or dedicated circuit as the control unit 21. That is, some or all of the functions of the control device 20 may be realized by hardware.

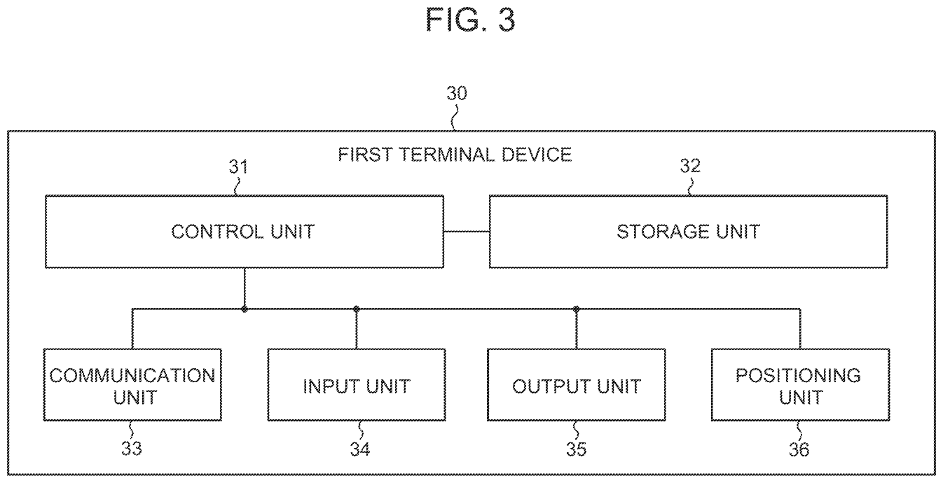

The configuration of the first terminal device 30 according to the embodiment will be described with reference to FIG. 3.

The first terminal device 30 includes a control unit 31, a storage unit 32, a communication unit 33, an input unit 34, an output unit 35 and a positioning unit 36.

The control unit 31 includes at least one processor, at least one programmable circuit, at least one dedicated circuit, or an arbitrary combination of them. The processor is a general-purpose processor such as a CPU or a GPU, or a dedicated processor for a particular process. For example, the programmable circuit is an FPGA. For example, the dedicated circuit is an ASIC. The control unit 31 executes processes relevant to the action of the first terminal device 30, while controlling each unit of the first terminal device 30.

The storage unit 32 includes at least one semiconductor memory, at least one magnetic memory, at least one optical memory, or an arbitrary combination of them. For example, the semiconductor memory is a RAM or a ROM. For example, the RAM is a SRAM or a DRAM. For example, the ROM is an EEPROM. For example, the storage unit 32 functions as a main storage device, an auxiliary storage device or a cache memory. In the storage unit 32, data to be used for the action of the first terminal device 30 and data obtained by the action of the first terminal device 30 are stored.

The communication unit 33 includes at least one communication interface. For example, the communication interface is an interface corresponding to a mobile communication standard such as LTE, the 4G standard or the 5G standard, an interface corresponding to a short-range wireless communication such as Bluetooth®, or a LAN interface. The “LTE” is an abbreviation of Long Term Evolution. The “4G” is an abbreviation of 4-th generation. The “5G” is an abbreviation of 5-th generation. The communication unit 33 receives the data to be used for the action of the first terminal device 30, and sends the data obtained by the action of the first terminal device 30.

The input unit 34 includes at least one input interface. For example, the input interface is a physical key, a capacitive key, a pointing device, a touch screen provided integrally with a display, a camera, or a microphone. The input unit 34 accepts an operation for inputting the data to be used for the action of the first terminal device 30. The input unit 34 may be connected to the first terminal device 30, as an external input device, instead of being included in the first terminal device 30. As the connection scheme, for example, an arbitrary scheme such as USB, HDMI® or Bluetooth® can be used.

The output unit 35 includes at least one output interface. For example, the output interface is a display or a speaker. For example, the display is an LCD or an organic EL display. The output unit 35 outputs the data obtained by the action of the first terminal device 30. The output unit 35 may be connected to the first terminal device 30, as an external output device, instead of being included in the first terminal device 30. As the connection scheme, for example, an arbitrary scheme such as USB, HDMI® or Bluetooth® can be used.

The positioning unit 36 includes at least one GNSS receiver. The “GNSS” is an abbreviation of global navigation satellite system. For example, the GNSS is GPS, QZSS, GLONASS or Galileo. The “GPS” is an abbreviation of Global Positioning System. The “QZSS” is an abbreviation of Quasi-Zenith Satellite System. Satellites in the QZSS are called quasi-zenith satellites. The “GLONASS” is an abbreviation of Global Navigation Satellite System. The positioning unit 36 measures the position of the first terminal device 30.

The function of the first terminal device 30 is realized when a first terminal program according to the embodiment is executed by a processor as the control unit 31. That is, the function of the first terminal device 30 is realized by software. The first terminal program causes a computer to execute the action of the first terminal device 30, and thereby causes the computer to function as the first terminal device 30. That is, the computer functions as the first terminal device 30 by executing the action of the first terminal device 30 in accordance with the first terminal program.

Some or all of the functions of the first terminal device 30 may be realized by the programmable circuit or dedicated circuit as the control unit 31. That is, some or all of the functions of the first terminal device 30 may be realized by hardware.

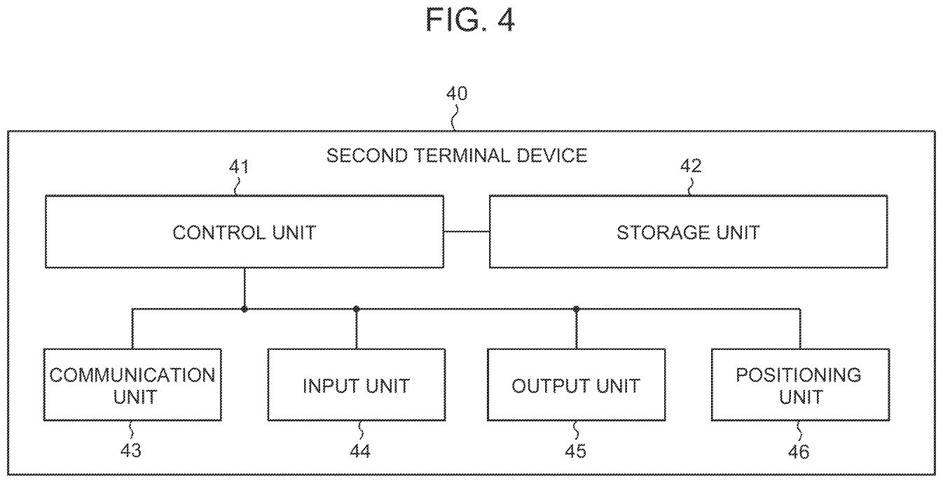

The configuration of the second terminal device 40 according to the embodiment will be described with reference to FIG. 4.

The second terminal device 40 includes a control unit 41, a storage unit 42, a communication unit 43, an input unit 44, an output unit 45 and a positioning unit 46.

The control unit 41 includes at least one processor, at least one programmable circuit, at least one dedicated circuit, or an arbitrary combination of them. The processor is a general-purpose processor such as a CPU or a GPU, or a dedicated processor for a particular process. For example, the programmable circuit is an FPGA. For example, the dedicated circuit is an ASIC. The control unit 41 executes processes relevant to the action of the second terminal device 40, while controlling each unit of the second terminal device 40.

The storage unit 42 includes at least one semiconductor memory, at least one magnetic memory, at least one optical memory, or an arbitrary combination of them. For example, the semiconductor memory is a RAM or a ROM. For example, the RAM is a SRAM or a DRAM. For example, the ROM is an EEPROM. For example, the storage unit 42 functions as a main storage device, an auxiliary storage device or a cache memory. In the storage unit 42, data to be used for the action of the second terminal device 40 and data obtained by the action of the second terminal device 40 are stored.

The communication unit 43 includes at least one communication interface. For example, the communication interface is an interface corresponding to a mobile communication standard such as LTE, the 4G standard or the 5G standard, an interface corresponding to a short-range wireless communication such as Bluetooth®, or a LAN interface. The communication unit 43 receives the data to be used for the action of the second terminal device 40, and sends the data obtained by the action of the second terminal device 40.

The input unit 44 includes at least one input interface. For example, the input interface is a physical key, a capacitive key, a pointing device, a touch screen provided integrally with a display, a camera, or a microphone. The input unit 44 accepts an operation for inputting the data to be used for the action of the second terminal device 40. The input unit 44 may be connected to the second terminal device 40, as an external input device, instead of being included in the second terminal device 40. As the connection scheme, for example, an arbitrary scheme such as USB, HDMI® or Bluetooth® can be used. In the embodiment, the camera 18 as an external input device is connected to the second terminal device 40.

The output unit 45 includes at least one output interface. For example, the output interface is a display or a speaker. For example, the display is an LCD or an organic EL display. The output unit 45 outputs the data obtained by the action of the second terminal device 40. The output unit 45 may be connected to the second terminal device 40, as an external output device, instead of being included in the second terminal device 40. As the connection scheme, for example, an arbitrary scheme such as USB, HDMI® or Bluetooth® can be used. In the embodiment, the display 17 as an external output device is connected to the second terminal device 40.

The positioning unit 46 includes at least one GNSS receiver. For example, the GNSS is GPS, QZSS, GLONASS or Galileo. The positioning unit 46 measures the position of the second terminal device 40.

The function of the second terminal device 40 is realized when a second terminal program according to the embodiment is executed by a processor as the control unit 41. That is, the function of the second terminal device 40 is realized by software. The second terminal program causes a computer to execute the action of the second terminal device 40, and thereby causes the computer to function as the second terminal device 40. That is, the computer functions as the second terminal device 40 by executing the action of the second terminal device 40 in accordance with the second terminal program.

Some or all of the functions of the second terminal device 40 may be realized by the programmable circuit or dedicated circuit as the control unit 41. That is, some or all of the functions of the second terminal device 40 may be realized by hardware.

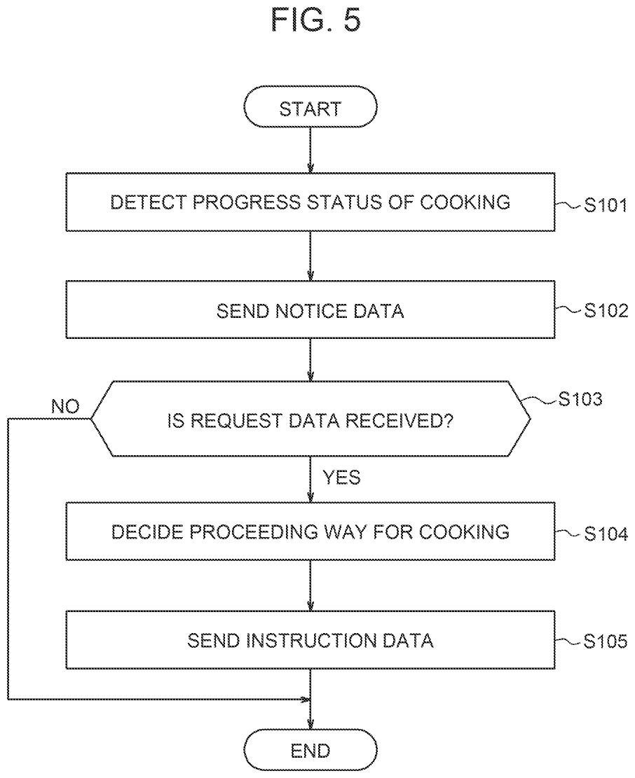

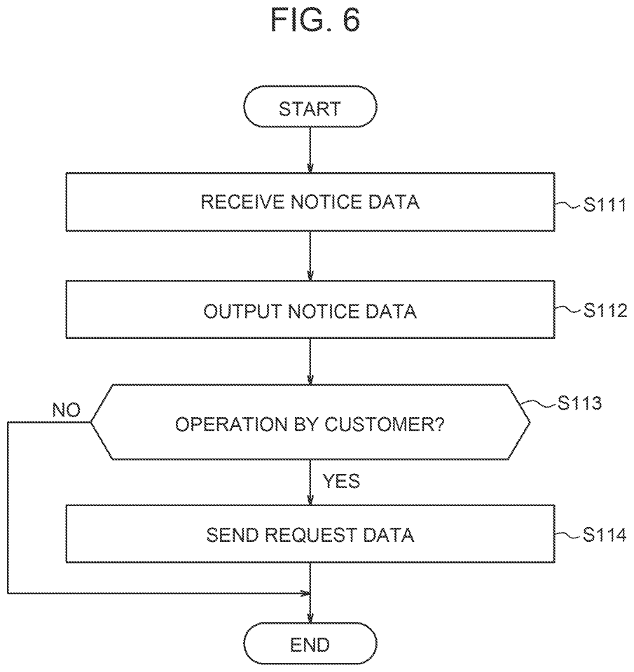

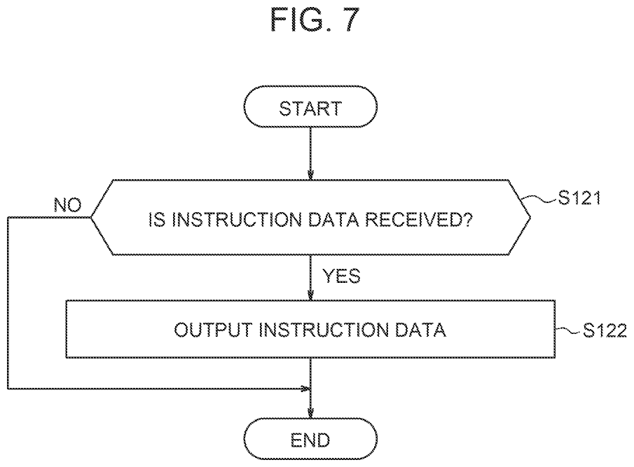

The action of the system 10 according to the embodiment will be descried with reference to FIG. 5 to FIG. 7. This action corresponds to a service support method according to the embodiment. FIG. 5 shows the action of the control device 20. FIG. 6 shows the action of the first terminal device 30. FIG. 7 shows the action of the second terminal device 40.

In step S101 of FIG. 5, the control unit 21 of the control device 20 detects the progress status of the cooking of one or more dishes ordered by the customer 12.

The progress status may be detected in an arbitrary procedure. In the embodiment, the progress status is detected in the following procedure.

The control unit 21 of the control device 20 acquires an image of the kitchen 15 that is picked up using the camera 18. The control unit 21 detects the progress status by analyzing the acquired image. Specifically, the control unit 21 recognizes the behavior of a person shown in the image. The control unit 21 detects the progress status depending on the recognized behavior.

For example, suppose that a salad, a fresh dish, a fried food and a grilled food have been ordered by the customer 12. Suppose that the cooking staff 14 shown in the image is making the salad. Suppose that the fresh dish, the fried food and the grilled food are usually made in this sequence after the salad, in the restaurant 11. In this case, the control unit 21 of the control device 20 estimate that the cooking staff 14 is making the salad, based on the behavior of the cooking staff 14. The control unit 21 refers to data relevant to the order of the customer 12, and detects that the salad of the four kinds of ordered dishes is being cooked and the fresh dish, the fried food and the grilled food do not start to be cooked, as the progress status.

The data relevant to the order may be acquired by an arbitrary method. For example, the data relevant to the order may be input to the first terminal device 30 by the customer 12, and may be acquired from the first terminal device 30. Alternatively, the data relevant to the order may be input to a third terminal device such as a tablet by a service staff of the restaurant 11, and may be acquired from the third terminal device. As a method for estimating what is being made based on the behavior of the person, an arbitrary method may be used, and for example, machine learning is used.

The progress status may be detected depending on the state of the cooking device 16 that is used for the cooking, instead of or in addition to the behavior of the person. In this modification, the control unit 21 of the control device 20 detects the state of the cooking device 16. Specifically, the control unit 21 acquires an image of the kitchen 15 that is picked up using the camera 18. The control unit 21 detects the state of the cooking device 16 by analyzing the acquired image. Alternatively, the control unit 21 detects the state of the cooking device 16 by communicating with the cooking device 16 through the communication unit 23. The control unit 21 detects the progress status depending on the detected state.

For example, suppose that two kinds of grilled foods have been ordered by the customer 12. Suppose that the cooking staff 14 shown in the image is making the first grilled food. In this case, the control unit 21 of the control device 20 estimates that the cooking staff 14 is making the first grilled food, based on the on-off state or heat level of the stove. The control unit 21 refers to the data relevant to the order of the customer 12, and detects that the first grilled food of the two kinds of ordered grilled foods is being cooked and the second grilled food does not start to be cooked, as the progress status.

The data relevant to the order may be acquired by an arbitrary method. For example, the data relevant to the order may be input to the first terminal device 30 by the customer 12, and may be acquired from the first terminal device 30. Alternatively, the data relevant to the order may be input to the third terminal device such as a tablet by the service staff of the restaurant 11, and may be acquired from the third terminal device. As a method for estimating what is being made based on the state of the cooking device 16, an arbitrary method may be used, and for example, machine learning is used.

In step S102 of FIG. 5, the communication unit 23 of the control device 20 sends the notice data D1 to the first terminal device 30. The notice data D1 is data about a notice of the progress status detected in step S101.

In step S111 of FIG. 6, the communication unit 33 of the first terminal device 30 receives the notice data D1 sent in step S102 of FIG. 5, from the control device 20.

In step S112 of FIG. 6, the control unit 31 of the first terminal device 30 performs a control to output the notice data D1 received in step S111. In accordance with this control, the output unit 35 of the first terminal device 30 outputs the notice data D1. For example, the display as the output unit 35 displays, on the screen, the progress status indicated by the notice data D1 for each dish, in a format such as a bar.

When the input unit 34 of the first terminal device 30 accepts an operation for requesting the adjustment of the proceeding way for the cooking as the operation by the customer 12 in step S113 of FIG. 6, the process of step S114 is performed. When the operation is not performed, the flow of FIG. 6 ends.

In the embodiment, a user interface for requesting the adjustment of the sequence of the cooking of the dishes is provided to the customer 12 through the input unit 34 and output unit 35 of the first terminal device 30. Alternatively, a user interface for requesting the adjustment of the pace of the cooking of the dishes is provided to the customer 12 through the input unit 34 and the output unit 35.

For example, the display as the output unit 35 of the first terminal device 30 displays, on the screen, the progress status indicating that the salad is being cooked and the fresh dish, the fried food and the grilled food do not start to be cooked, and photographs of the salad, the fresh dish, the fried food and the grilled food, in the sequence of the cooking. When the customer 12 wants to eat the fried food next to the salad, the touch screen as the input unit 34 of the first terminal device 30 accepts a GUI operation for requesting the change in the sequence of the fresh dish and the fried food, as the operation by the customer 12. The “GUI” is an abbreviation of graphical user interface.

Alternatively, the display as the output unit 35 of the first terminal device 30 displays, on the screen, the progress status indicating that the first grilled food is being cooked and the second grilled food does not start to be cooked, and photographs of the two kinds of grilled foods, in the sequence of the cooking. When the customer 12 wants to eat the second grilled food after slowly eating another dish, the touch screen as the input unit 34 of the first terminal device 30 accepts a GUI operation for requesting the decrease in the pace of the cooking of the two kinds of grilled food, as the operation by the customer 12.

In step S114 of FIG. 6, the control unit 31 of the first terminal device 30 generates the request data D2 depending on the operation in step S113. The request data D2 is data about the request for the adjustment of the proceeding way for the cooking. The communication unit 33 of the first terminal device 30 sends the request data D2 generated by the control unit 31, as the response to the notice data D1.

In the embodiment, the request data D2 includes data about the request for the adjustment of the sequence of the cooking of the dishes. Alternatively, the request data D2 includes data about the request for the adjustment of the pace of the cooking of the dishes.

For example, when the GUI operation for requesting the change in the sequence of the fresh dish and the fried food is performed in step S113 of FIG. 6, the control unit 31 of the first terminal device 30 generates data about the request for the change in the sequence of the cooking of the fresh dish and the fried food, as the request data D2. Alternatively, when the GUI operation for requesting the decrease in the pace of the cooking of the two kinds of grilled foods is performed in step S113, the control unit 31 generates data about the reduction in the pace of the cooking of the two kinds of grilled foods, as the request data D2.

When the communication unit 23 of the control device 20 receives the request data D2 sent in step S114 of FIG. 6 from the first terminal device 30 as the response to the notice data D1 in step S103 of FIG. 5, the process of step S104 is performed. When the request data D2 is not received, the flow of FIG. 5 ends.

In step S104 of FIG. 5, the control unit 21 of the control device 20 generates the instruction data D3 based on the request data D2 received in step S103. The instruction data D3 is data about the instruction on the proceeding way for the cooking.

Specifically, the control unit 21 of the control device 20 decides the proceeding way for the cooking depending on the request in the request data D2. The control unit 21 generates data about an instruction to adopt the decided proceeding way, as the instruction data D3.

For example, in the case of the request for the change in the sequence of the cooking of the fresh dish and the fried food, the control unit 21 of the control device 20 decides to cook the fresh dish and the fried food in the reverse sequence. Alternatively, in the case of the request for the reduction in the pace of the cooking of the two kinds of grilled foods, the control unit 31 decides to cook the second grilled food after an interval from the cooking of the first grilled food.

In the case where a plurality of dishes are ordered by a plurality of customers including the customer 12, the control unit 21 of the control device 20 may decide the proceeding way for the cooking, depending on the request in the request data D2 and the kind of each dish. For example, the control unit 21 decides to make the same kinds of dishes together, instead of simply making the dishes in a sequence in which the dishes are ordered. As a result, the enhancement of the efficiency of the cooking is expected.

In step S105 of FIG. 5, the communication unit 23 of the control device 20 sends the instruction data D3 generated in step S104, to the second terminal device 40.

When the communication unit 43 of the second terminal device 40 receives the instruction data D3 sent in step S105 of FIG. 5 from the control device 20 in step S121 of FIG. 7, the process of step S122 is performed. When the instruction data D3 is not received, the flow of FIG. 7 ends.

In the step S122 of FIG. 7, the control unit 41 of the second terminal device 40 performs a control to output the instruction data D3 received in step S121. In accordance with this control, the display 17 outputs the instruction data D3.

For example, the display 17 displays, on the screen, a message for instructing the cooking staff 14 to cook the fresh dish and the fried food in the reverse sequence. Alternatively, the display 17 displays, on the screen, a message for instructing the cooking staff 14 to cook the second grilled food after an interval from the cooking of the first grilled food.

As described above, in the embodiment, the control unit 21 of the control device 20 detects the progress status of the cooking of the dishes ordered by the customer 12. The output unit 35 of the first terminal device 30 displays the detected progress status of the cooking. The input unit 34 of the first terminal device 30 accepts the input of the request for the change in the cooking. The control unit 21 of the control device 20 gives the notice of the input request for the change in the cooking.

With the embodiment, the customer 12 can know the progress status of the cooking of the ordered dishes. The customer 12 can request the change in the cooking depending on the progress status of the cooking. The cooking staff 14 can cope with the demand from the customer 12.

The control unit 21 of the control device 20 may give an instruction on the cooking sequence in the whole process, to the cooking staff 14, depending on the progress status of the cooking of the dishes ordered by a plurality of customers including the customer 12 and other customers and requests for the change in the cooking from a plurality of customers.

The display 17 may function as an AI cooking instruction board for giving an instruction to perform a cooking decided by an AI, depending on the progress status of the cooking by the cooking staff 14 and the progress status of the eating by the customer 12. The “AI” is an abbreviation of artificial intelligence. The progress status of the eating can be detected, for example, by analyzing the image of the table 13 that is picked up using the camera or by reading data of an IC tag attached to a plate. The “IC” is an abbreviation of integrated circuit. The AI cooking instruction board gives a notice of a cooking sequence that allows the completion in the shortest time.

The control unit 21 of the control device 20 may evaluate the cooking speed of the cooking staff 14, by analyzing the image of the kitchen 15 that is picked up using the camera 18. The evaluation result can be used for training the cooking staff 14.

The present disclosure is not limited to the above-described embodiment. For example, a plurality of blocks described in the block diagram may be integrated, or one block may be divided. Instead of executing a plurality of steps described in the flowcharts in series in accordance with the description, it is allowable to execute the steps in parallel or in a different sequence, depending on processing powers of the devices that execute the steps or as necessary. In addition, modifications can be made without departing from the spirit of the present disclosure.

For example, the control device 20 may be installed at the kitchen 15 in the restaurant 11 or at another place. In this case, at least a part of the action of the second terminal device 40 may be performed by the control device 20. The second terminal device 40 may be integrated in the control device 20. The control unit 21 of the control device 20 may display the instruction data D3 on the display 17 installed at the kitchen 15.

What is claimed is:

1. A control device comprising:
a control unit configured to detect a progress status of cooking of one or more dishes ordered by a customer; and
a communication unit configured to send notice data to a terminal device that is used by the customer, the notice data being data about a notice of the progress status detected by the control unit.

2. The control device according to claim 1, wherein when the communication unit receives a request data as a response to the notice data, the control unit generates instruction data based on the request data, the request data being data about a request for an adjustment of a proceeding way for the cooking, the instruction data being data about an instruction on the proceeding way for the cooking.

3. The control device according to claim 2, wherein the request data includes data about a request for an adjustment of a sequence of the cooking of the dishes.

4. The control device according to claim 2, wherein the request data includes data about a request for an adjustment of a pace of the cooking of the dishes.

5. The control device according to claim 2, wherein when the request data is received and a plurality of dishes are ordered by a plurality of customers including the customer, the control unit decides the proceeding way for the cooking, depending on the request in the request data and the kind of each dish, and generates data about an instruction to adopt the decided proceeding way, as the instruction data.

6. The control device according to claim 2, wherein the communication unit sends the instruction data to another terminal device that is used by a cooking staff.

7. The control device according to claim 2, wherein the control unit displays the instruction data on a display that is installed at a kitchen.

8. The control device according to claim 1, wherein the control unit acquires an image of a kitchen that is picked up using a camera, and detects the progress status by analyzing the acquired image.

9. The control device according to claim 8, wherein the control unit recognizes a behavior of a person shown in the image, and detects the progress status depending on the recognized behavior.

10. The control device according to claim 1, wherein the control unit detects a state of a cooking device that is used for the cooking, and detects the progress status depending on the detected state.

11. A system comprising:
the control device according to claim 1; and
the terminal device.

12. The system according to claim 11, wherein the terminal device is installed on a table in a restaurant.

13. A program that causes a computer to execute an action comprising:
receiving notice data from a control device configured to detect a progress status of cooking of one or more dishes ordered by a customer, the notice data being data about a notice of the progress status;
performing a control to output the received notice data;
generating request data depending on an operation by the customer, the request data being data about a request for an adjustment of a proceeding way for the cooking; and
sending the generated request data as a response to the notice data.

14. The program according to claim 13, wherein the request data includes data about a request for an adjustment of a sequence of the cooking of the dishes.

15. The program according to claim 13, wherein the request data includes data about a request for an adjustment of a pace of the cooking of the dishes.

16. A terminal device that executes the action in accordance with the program according to claim 13.

17. A service support method comprising:
detecting a progress status of cooking of one or more dishes ordered by a customer, using a control device; and
sending notice data from the control device to a terminal device that is used by the customer, the notice data being data about a notice of the detected progress status.

18. The service support method according to claim 17, further comprising:
generating request data depending on an operation by the customer, using the terminal device, the request data being data about a request for an adjustment of a proceeding way for the cooking; and
sending the generated request data from the terminal device to the control device, as a response to the notice data.

19. The service support method according to claim 18, further comprising generating instruction data based on the request data, using the control device, the instruction data being data about an instruction on the proceeding way for the cooking.

20. The service support method according to claim 18, wherein the request data includes data about a request for an adjustment of a sequence or pace of the cooking of the dishes.
